(19) United States
(12) Patent Application Publication
(10) Pub. No.: US 2011/0100472 A1
(43) Pub. Date: May 5, 2011

(54) PASSIVE PREPROGRAMMED LOGIC SYSTEMS USING KNOTTED/STRTCHABLE YARNS and THEIR USE FOR MAKING MICROFLUIDIC PLATFORMS

(76) Inventors: DAVID JUNCKER, Montreal (CA); ROOZBEH SAFAVIEH, Montreal (CA)

(21) Appl. No.: 12/917,436

(22) Filed: Nov. 1, 2010

Related U.S. Application Data
(60) Provisional application No. 61/256,585, filed on Oct. 30, 2009.

(51) Int. Cl. G05D 7/00; D02G 3/02; D04G 5/00

(52) U.S. Cl. 137/2; 57/252; 289/1.2

(57) ABSTRACT

We describe various methods for making preprogrammed logic systems using knotted yarns. We show that the topology of the knots controls the mixing ratio of the reagents coming into the knots, and thus the ratio can be adjusted by choosing a specific knot. A serial dilutor is built by knotting multiple yarns into a web of well defined dimension. In addition stretchable yarn can be used to control the capillary pressure and hence the flow rate of the liquid, by pulling the yarn. Furthermore, we demonstrate the possibility of patterning impermeable/hydrophobic regions in to the yarn. Finally, we propose that biodegradable yarns can be used into these platforms to build various multi/single cellular scaffolds.

### CROSS-REFERENCE TO RELATED APPLICATIONS

This application claims the benefit of U.S. provisional Application No. US 61 256 585, filed Oct. 31, 2009, the content of which incorporated in their entirely herein.

### BACKGROUND

Yarns are currently being used in Microfluidic Applications. However, these devices are limited in performing passive preprogrammed logic systems. Thus, there remains a need for various elements such as methods for controlling the mixing ratios of the reagents, and/or controlling the flow rate of the liquid.

### SUMMARY

Yarn can easily be knotted, and knots lend themselves to splitting and merging liquid streams on yarns, and may thus be used as a functional element for making microfluidic networks. A simple three-way splitter with a blue dye being distributed into outlet yarns is shown in FIG. 1A. Merging and mixing of two streams is illustrated with a blue and a yellow dye merging into a green one (FIG. 1B)

Knot topology can be used to control the mixing ratio between two inlets and two outlets. The overhand knot results in equal mixing ratios in both outlet yarns; however, when it is rotated 90°, using the two ends of one of the yarns as inlets, and the other yarn as outlets, the mixing is almost entirely suppressed, FIG. 1D-F. A thin line of green color appears on the right yarn after a while, which reflects slightly unequal flow rates in each branch and which arise due to inhomogeneities in the yarn and variation in wicking speed. The hunter's knot shows much less intertwining of the two yarns (FIG. 1G), and results in almost no mixing with a 90:10 ratio of the two fluids in each outlet, FIG. 1H. Conversely, after rotating it by 90° as above, the mixing ratio was 70:30 between the two outlets FIG. 1I. These results illustrate that knot topology can be used to conveniently control mixing of different fluids, and based on the large variety of knots that exist, many more mixing combinations appear feasible.

Yarn based Microfluidic Networks can be made by knotting multiple knots into a web. As an example a microfluidic serial dilutor was made by knotting multiple yarns into a web using overhand knots, FIG. 2A

Yarns can be made partially/completely hydrophobic/impermeable, by spraying a water proof wax, using a molten paraffin, or other techniques. FIG. 3, and FIG. 4. Patterning hydrophobic areas into a hysrophilic yarn can be either used as a displacement valve integrated into Microfluidic devices or a method to store/transfer various reagents

Stretchable yarn can be used to control the capillary pressure and hence the flow rate of the liquid when it is pulled or pushed. FIG. 5

Various Stretchable, and non stretchable yarns can be connected by knotting for making passive Microfluidic platforms

### BRIEF DESCRIPTION OF THE DRAWINGS

FIG. 1. Knots used as microfluidic splitters, mixers, and for controlling mixing ratios. (A) A microfluidic splitter used in reverse (B) becomes an efficient mixer, and (C) when combining both, splitting and mixing is observed. (D) Schematic of the overhand knot, which (E) leads to an equal distribution and mixing of yellow and blue dyes when used as depicted, and (F) to complete separation of the dyes in each outlet when rotated by 90°. (G) Schematic of the hunter's knot, which (H) leads to 90:10 mixing ratio when used as shown, and (I) when rotated by 90° leads to a 70:30 mixing ratio.

FIG. 2. A Serial dilutor after introducing yellow and blue food dyes at each inlet. The dilutor iteratively combines, mixes, and splits two dyes to create 6 outlets with a serial dilution of both chemicals in each outlet. (A) Inlets 1 and 2 are fed with blue and yellow dyes respectively, and in outlets 3-8 the dyes are expected to be mixed with a ratio blue:yellow of 0:100, ˜25:75, ˜50:50, ˜50:50, ˜75:25 and 100:0, respectively

FIG. 3. Schematic illustrating a hydrophilic yarn patterned with hydrophobic/impermeable regions. Various methods such as lithography, or printing can be used for patterning the yarn.

FIG. 4 A hydrophobic thread formed by spraying a natural cotton yarn sprayed with a water proof wax

FIG. 5 Stretchable yarn linked to a rigid substrate to control the capillary pressure.

FIG. 6 A platforms of stretchable yarn linked to microchannels to fill and drain the liquids sequentially by capillarity

FIG. 7 A knotted web serving as a fluidic circuit. (A) Photograph of the web made using overhand knots used for branching and mixing. Six pieces of yarns and eight knots were employed to form this circuit, which can be used as a serial dilutor. To determine the ratio of fluid 1 and 2 in each outlet, an equivalent electrical circuit model was derived by drawing an equivalent circuit made of resistances and nodes whereas the colors represent different yarns (B). The links within the web have been assigned a flow resistance r, the outlet yarns a resistance nr, and the inlet yarns a resistance mr with n and m expressing a ratio. P₁ is the capillary pressure generated by a wick placed at a constant distance from the outlet node on the yarn. The ratio of fluid 1 and 2 is 50:50 in outlets 5 and 6 based on the symmetry of the circuit, and 100:0 and 0:100 in outlets 8 and 3, respectively. Again, based on symmetry circuit, it is sufficient to analyze the right half of the circuit in (B). Defining X as reference P₀=0, the circuit can be redrawn as shown in (C). The ratio between flow rate Q₁ and Q₂ determines the concentration at outlet 4 (and thus 7);

Cotton yarns used for carrying out a sandwich immunoassay. (A) Scanned images of 4 representative yarns, showing pairs of yarns connected to a single capillary pump made of a bundle of short yarns. 1 μg/ml of CRP was flowed through the left yarns, and a control sample (PBS) through the right yarns. The binding was revealed by flowing a detection antibody conjugated to Au—NP that produce a red color upon binding. (B) The intensity of the signal for 10 sample yarns significantly higher than for the 4 control yarns. Bars are standard error. *, p<0.001.

### DETAILED DESCRIPTION

All publications, patent applications, patents, and other references mentioned herein are incorporated by reference in their entirely, In addition, the materials, methods, and examples are illustrative only and not intended to be limiting. Unless otherwise defined, all technical and scientific terms used herein have the same meaning as commonly understood by one of ordinary skill in the art to which this invention belongs.

### I. Microfluidic Platforms

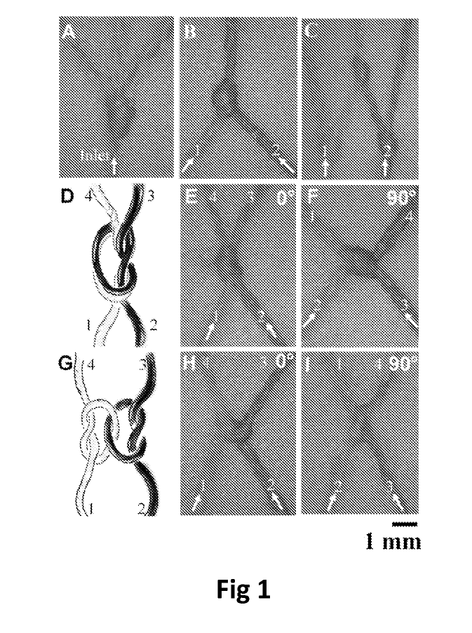

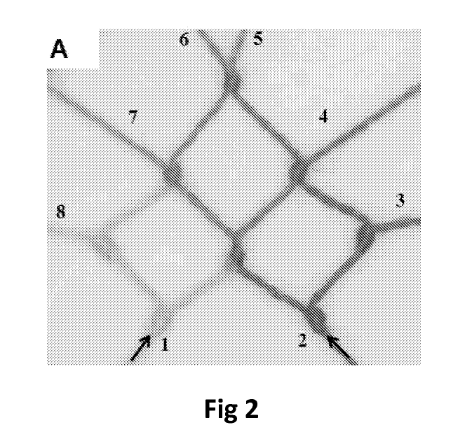

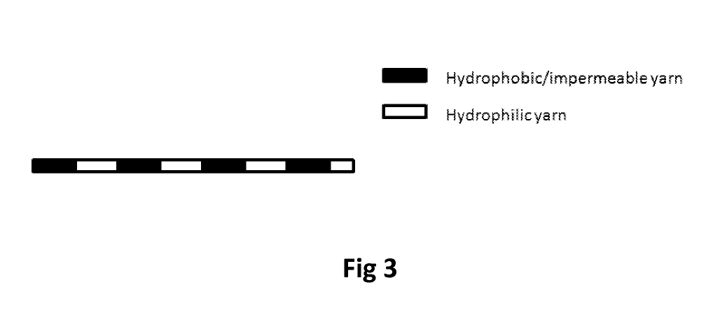

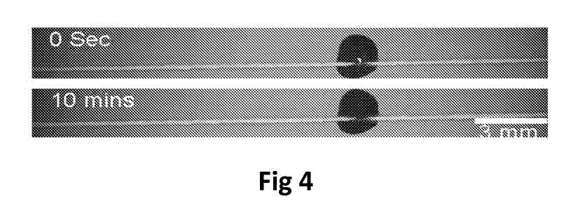

With reference to FIGS. 1 and 2, a few non limiting platforms can be made to accurately mix/dilute various liquids, and can be used for making multistep assays.

FIG. 2 illustrates a serial dilutor configuration using a web of knots. With reference to FIG. 2, one may make a device to study cell survival, by seeing cells in the yarns, and investigating the effect of various concentrations of the drugs using a web

With reference to FIGS. 1 and 2, Biodegradable yarns can be used into these platforms to build various multi/single cellular scaffolds.

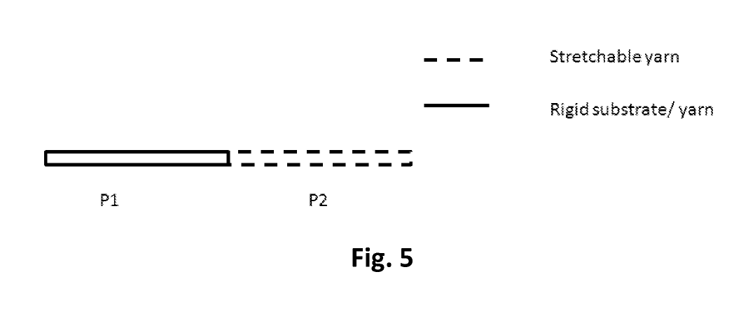

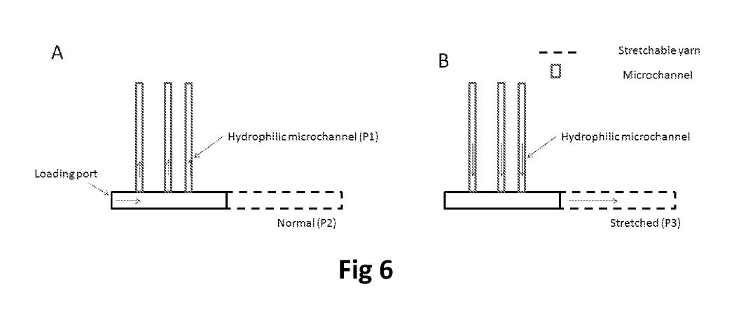

With reference to FIG. 5 one may control the flow rate by stretching the yarn. In combination with microchannels, various platforms can be made in which a liquid would fill the microchannels, and once the yarn is stretched the liquids are drained from the microchannels. FIG. 6

### II. Examples

### Example 1

### Using a Preprogrammed Serial Dilutor To

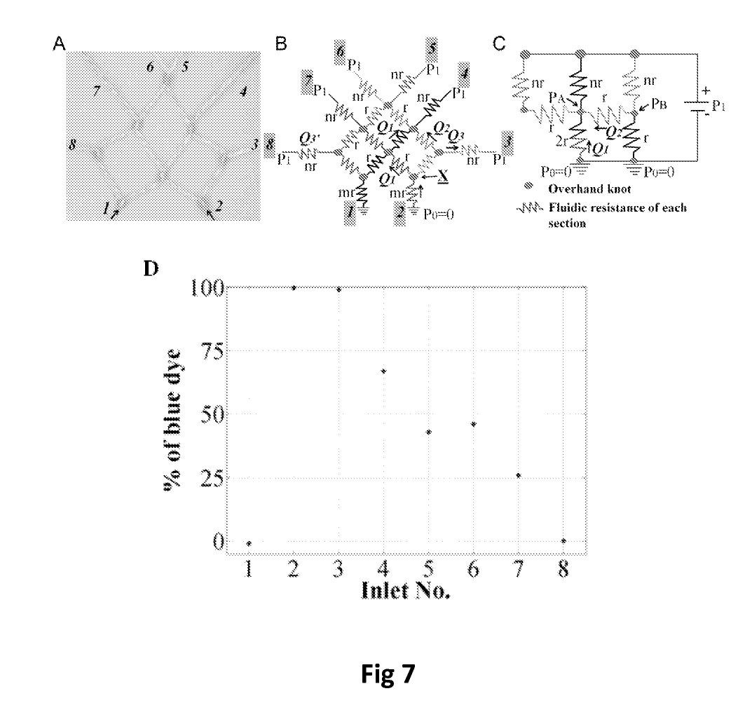

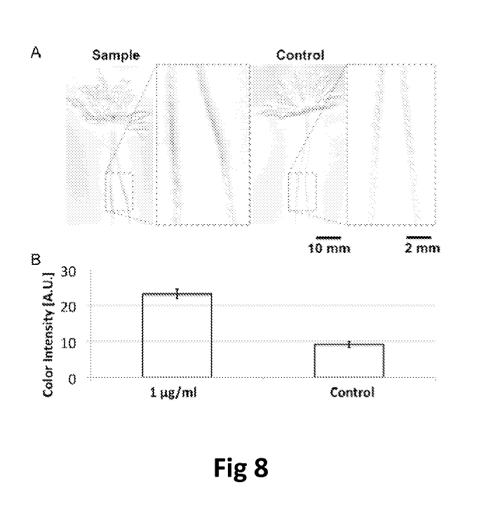

With reference to FIG. 7C, we perform a nodal analysis to calculate the flow rate ratio and concentration C₄ at outlet 4 (and the complementary concentration C₇ at outlet 7) as a function of the ratio between the resistance of one branch r and the outlet resistance given by nr with n being a proportionality factor. First we write the equations for the current at node A and B based on the unknown potential P_{A} and P_{B}:

$$\{ \begin{matrix}\frac{{P}_{1} - {P}_{A}}{( n + 1 ) r} + \frac{{P}_{1} - {P}_{A}}{nr} + \frac{{P}_{B} - {P}_{A}}{r} - \frac{{P}_{A}}{2 r} = 0 & ( S 1 ) \\ \frac{{P}_{1} - {P}_{B}}{nr} + \frac{{P}_{A} - {P}_{B}}{r} - \frac{{P}_{B}}{r} = 0 & ( S 2 )\end{matrix}$$

The equations can be simplified rewritten as:

$$\{ \begin{matrix}{P}_{A} \frac{3 {n}^{2} + 7 n + 2}{2 {n}^{2} + 2 n} - {P}_{B} = {P}_{1} \frac{2 n + 1}{{n}^{2} + n} & ( S 3 ) \\ - {P}_{A} + {P}_{B} \frac{2 n + 1}{n} = {P}_{1} \frac{1}{n} & ( S 4 )\end{matrix}$$

Multiplying equation S4 by

$$\frac{n}{2 n + 1}$$

and combining equations S3 and S4 together we obtain:

$$\{ \begin{matrix}{P}_{A} = \frac{10 {n}^{2} + 10 n + 2}{4 {n}^{3} + 15 {n}^{2} + 11 n + 2} {P}_{1} & ( S 5 ) \\ {P}_{B} = \frac{14 {n}^{3} + 25 {n}^{2} + 13 n + 2}{4 {n}^{3} + 15 {n}^{2} + 11 n + 2} & ( S 6 )\end{matrix}$$

To identify the concentration of the liquid at the exit 4, and 7, we need to determine the ratio of the flow rates of

$$k = \frac{{Q}_{2}}{{Q}_{1}} , where {Q}_{1} = \frac{{P}_{A}}{2 r} , and {Q}_{2} = \frac{{P}_{A} - {P}_{B}}{r} .$$

$$k = \frac{{Q}_{2}}{{Q}_{1}} = \frac{3 {n}^{2} + n}{5 {n}^{2} + 5 n + 1} \qquad ( S7 )$$

Having the flow ratios, the concentration of fluid 2 in exit 4, C₄, can be approximated using a weighted average of the concentrations of each branch,

$${C}_{4} = \frac{{C}_{1} {Q}_{1} + {C}_{2} {Q}_{2}}{{Q}_{1} + {Q}_{2}} \qquad ( S 8 )$$

where C₁=0, and C₂=0.5.

Substituting the concentrations of the liquids and the flow rates in to the eq. S8 we have

$${C}_{4} = \frac{0.5}{k + 1} \qquad ( S9 )$$

and similarly the concentration of fluid at exit 7 is given by the ratios of the mirror flow rates Q₁′ and Q₂′, and the concentrations C₁′ and C₂′. Using the fact that C₄+C₇=1 we find:

$${C}_{7} = \frac{{C}_{1} {Q}_{1} + {C}_{2} {Q}_{2}}{{Q}_{1} + {Q}_{2}} = \frac{k + 0.5}{k + 1}$$

We then measured the concentrations of blue and yellow dyes in FIG. 2, and saw that the approximated results are in a good agreement with the experimental one, FIG. 7D

### Example 2

### Using Knotted Microfluidics to Measure CRP in Blood

We selected C-reactive protein (CRP) to test whether it might be feasible. CRP is found at an average concentration of 0.8 μg/ml in the blood in healthy young adults, and can rise to between 40 μg/ml and 500 μg/ml in response to infection and diseases such as cardiac disease, diabetes and sometimes cance. We developed a protocol for a sandwich immunoassay on cotton yarn that emulates lateral flow assays and features a visual read-out. First, a small section of the yarn was coated with a capture antibody using a pipette. The subsequent samples were then all flowed by capillary effects by sequentially dipping the end of the yarn into Eppendorf tubes containing each of the different solutions. To increase the volume of sample that could be flushed through the yarn, many short yarns were knotted into a bundle at the end of the main yarn and served as a capillary pump, FIG. 8A. First, PBS was flowed followed by bovine serum albumin (BSA) to block the surface. 10 μl of CRP at a concentration of 1 μg/ml (and PBS only for the control yarn) were flowed for 30 minutes, followed by 10 μl of the detection antibody conjugated to gold nano-particles (Au—NP) for 10 min, and then PBS for rinsing. The Au—NP conjugated detection antibody forms a sandwich complex upon binding, and the accumulation of Au—NP results in a red color stripe that was visible to the naked eye, FIG. 8A. Images were recorded using a scanner and the binding quantified as the average color hue change. The results for 10 samples and 6 controls are reported in FIG. 8B, and show a significant difference. These results suggest that yarn might be used to detect proteins at clinically useful levels in a sample. The signal in the negative control yarn is due both to low non-specific binding of gold nanoparticles, and to the natural twist in the yarn that gives rise to a non-homogeneous background.

### EQUIVALENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims

1. Using knots for splitting, merging, and mixing of various liquids, and the use of topologically different knots to create different Mixing ratios of two/multiple liquids:

2. Hydrophilic yarn patterned with hydrophobic/impermeable regions, and the use of that as a method to transfer/print the liquids, or displacement vales.

3. Stretchable yarn as a fluid carrier with the ability to control the capillary pressure along the yarn, once it is being pulled/pushed.

4. With reference to claim 3, A platform of stretchable/rigid yarn linked to microchannels to fill and drain the liquids sequentially by capillarity

5. A Serial dilutor made out of knots described in claim 1.

6. With reference to claims 1-5, biodegradable yarns can be used into these platforms to build various multi/single cellular scaffolds.
